(19) United States
(12) Patent Application Publication
(10) Pub. No.: US 2014/0374351 A1
(43) Pub. Date: Dec. 25, 2014

(54) BRACKISH WATER DESALINATION USING TUNABLE ANION EXCHANGE BED

(71) Applicant: Lehigh University, Bethlehem, PA (US)

(72) Inventors: Arup K. SenGupta, Bethlehem, PA (US); Ryan C. Smith, Bethlehem, PA (US)

(73) Assignee: Lehigh University, Bethlehem, PA (US)

(21) Appl. No.: 14/289,134

(22) Filed: May 28, 2014

Related U.S. Application Data
(60) Provisional application No. 61/828,477, filed on May 29, 2013.

(51) Int. Cl. C02F 1/42; C02F 1/44; C02F 1/06

(52) U.S. Cl. CPC C02F 1/42; C02F 1/06; C02F 1/441; C02F 2001/422; C02F 2101/101
USPC 210/638; 210/670; 210/677; 210/664; 210/269; 210/252; 210/259; 210/182

(57) ABSTRACT

A process for treating feed water for desalination, the process comprising: (a) removing one or more polyvalent anions from the feed water by feeding the feed water into a bed comprising one or more anion exchange resins under conditions sufficient to exchange the polyvalent ions in the feed water with one or more monovalent anions in the resin; and (b) regenerating the bed by feeding a brine stream into the bed under conditions sufficient to exchange one or more polyvalent anions in the resins with one or more monovalent anions in the brine stream.

### REFERENCE TO RELATED APPLICATION

This application claims priority to Provisional Application No. 61/828,477, filed May 29, 2013, hereby incorporated by reference in its entirety.

### FIELD OF INVENTION

The present invention relates to a system and process that produces potable water from various saline sources through the use of a bed of mixed anion exchange resins to eliminate scaling in desalination processes.

### BACKGROUND OF THE INVENTION

Desalination processes separate dissolved salts from the solute water. For example, thermal processes heat brine and collect the produced vapor, and membrane processes using a semi-permeable membrane to remove the water from the salt. There are many types and methods of desalination practiced, but all produce essentially the same result--potable water and concentrated brine containing the leftover salt from the feed water.

Significant challenges face the management and disposal of concentrated brine in an environmentally-friendly and cost-effective manner. For desalting plants located next to the coast, this brine is normally discharged back into the ocean; however, inland plants must resort to other, more costly, disposal methods. Commonly-practiced methods include, for example, evaporation ponds and deep-well injection, which can contribute significantly to plant operating costs. For example, concentrate disposal often constitutes 50% of the total operating expense. Therefore, any reductions in the volume of produced brine will reduce disposal costs. For example, an increase in process recovery from 80% to 90% will result in a 50% decrease in concentrate volume

Increasing the recovery of the desalination process to reduce brine volume, however, is challenging. Specifically, as the recovery of the desalination process increases, the concentration of the reject brine becomes so high that the solubility of salts, like calcium carbonate and/or calcium sulfate and/or calcium phosphate, is exceeded, causing them to precipitate and form scale. The formation of scale from these insoluble salts tends to hinder the effectiveness of the desalination process if left unchecked. For reverse osmosis or RO processes, the precipitates irreversibly foul membranes.

One approach to preventing the precipitation of these insoluble salts involves dosing acid or anti-scaling chemicals into the feed water. However, these anti-scalants are usually organophosphate compounds which pose environmental problems in disposal. Moreover, upon discharge into the environment, any dosed chemicals in the feed have been concentrated several times during the desalination process making the effluent particularly problematic to the environment.

This combination of chemical dosing, lowered process recovery, and brine disposal costs causes a significant increase in the operational costs of a desalination process. Therefore, a need exists to reduce brine volume without the use of environmentally-problematic acids and anti-scaling agents. The present invention fulfils this need, among others.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention involves a system and method for continuously treating feed water for desalination to reduce the concentration of less-soluble salts of polyvalent ions. Specifically, the invention involves the use of a bed of one or more anion exchange resins for which the overall polyvalent/monovalent ion selectivity is tunable so that no regenerant is needed for sustained operation with an integrated desalination process. More specifically, the bed is tuned to be selective of polyvalent anions over monovalent anions for a specific brackish feed water composition, yet selective of monovalent anions over polyvalent anions for a concentrated brine which functions as the regenerant to regenerate the bed. In this way, the polyvalent anions in the feed water are preferentially substituted for an equivalent amount of monovalent anions, the salts of which are orders of magnitude more soluble than polyvalent anion salts. Thus, as the feed stream is subject to desalination and the salts become more concentrated, they are less likely to precipitate and cause scaling. The brine stream from the desalination process, which is concentrated with monovalent anions, principally chloride, is then flushed back through the bed to regenerate the mixed anion exchange resin to sustain the beds ion exchange capacity. Thus, the bed treats the feed stream to the desalination process to remove the scale-causing polyvalent ions and is regenerated by the brine stream. The result is a sustained desalination process in which no acids or anti-scaling agents are used, and the reject brine volume is minimal.

In one embodiment, the present invention uses a mixed bed, which enhances its ability to be “tuned” for different feed waters. More specifically, applicant recognizes that the ion exchange depends on a separation factor, which is a function of the relative concentration of the polyvalent ion in the resin and the solution contacting the resin (i.e., the feed water or brine), and of the relative concentration of the monovalent ion in the resin and in the solution contacting the resin. Applicant also recognizes that some resins will have a preference for polyvalent ions, which is beneficial for treating the feed water, while other resins will have a preference for monovalent ions, which is beneficial for regenerating the bed. The bed can therefore be tuned for a particular composition of feed water by mixing the resins to ensure that the exchange promotes the exchange of polyvalent ions for monovalent ions in one direction (treating the feed water) and the exchange of monovalent ions for polyvalent ions in the other direction (regenerating the bed). Furthermore, the present invention is not limited to a specific type of desalination process, and can be practiced with membrane processes and thermal processes.

Accordingly, one aspect of the invention is a sustainable process for treating feed water for desalination using a mixed bed of anion exchange resins. In one embodiment, the process comprises: (a) removing one or more polyvalent anions from the feed water by feeding the feed water into a bed comprising one or more anion exchange resins under conditions sufficient to exchange the polyvalent anions in the feed water with one or more monovalent anions in the resin; and (b) regenerating the bed by feeding a brine stream into the bed under conditions sufficient to exchange one or more polyvalent anions in the resins with one or more monovalent anions in the brine stream.

Yet another aspect of the invention is a system for treating the feed water of a desalination system comprising a bed of one or more anion exchange resins. In one embodiment, the system comprises: (a) an anion exchange bed for removing one or more polyvalent anions from the feed water; (b) a first input for feeding the feed water into the bed; (c) a first output for outputting a treated stream of feed water to a desalination system; (d) a second input for feeding a brine stream from the desalination system into the bed; (e) a second output for outputting a used brine stream; and (f) one or more anion exchange resins in the bed, the resins selecting polyvalent anions over monovalent anions when contacted with the feed water, and selecting monovalent anions over polyvalent anions when contacted with the brine stream

Still another aspect of the invention is a desalination system comprising a mixed bed of anion exchange resins. In one embodiment, the desalination system comprises: (a) a desalination system; (b) an ion exchange bed for removing one or more polyvalent ions from the feed water; (c) a first input for feeding the feed water into the bed; (d) a first output for outputting a treated stream of feed water to the desalination system; (e) a second input for feeding a brine stream from the desalination system into the bed; (f) a second output for outputting a used brine stream; and (g) one or more anion exchange resins in the bed, the resins selecting polyvalent ions over monovalent ions when contacted with the feed water, and selecting monovalent ions over polyvalent ions when contacted with the brine stream.

### BRIEF DESCRIPTION OF DRAWINGS

FIG. 1 is a plot of CaSO₄ Supersaturation Index (SI) (i.e., degree of solubility) for various feed waters as a function of desalination recovery. (Note that with high recovery, SI tends to be greater than unity).

FIG. 2 is a flow chart of the Reversible Ion Exchange-Desalination (RIX-D) Process.

FIG. 3A is a plot of ion exchange selectivity for an acrylic resin and a styrene/divinylbenzene resin.

FIG. 3B is a plot of ion exchange selectivity for resins with different functional groups.

FIG. 4 is a plot of the variation in CaSO4 supersaturation index for two different feed waters: one with no modification and another with 90% sulfate removed.

FIG. 5A is a plot of the theoretical ion exchange selectivity for a styrene/divinylbenzene strong base anion exchange resin at 80 meq/L and 400 meq/L.

FIG. 5B—is a plot of the theoretical ion exchange selectivity for an acrylic strong base anion exchange resin at 80 meq/L and 400 meq/L.

FIG. 6A is a diagram indicating that the mixture of two characteristically different ion exchange resins can change the overall selectivity of the resins.

FIG. 6B is a plot of ion exchange selectivity for a 50/50 mixed bed of acrylic strong base anion exchange resin and styrene/divinylbenzene strong base anion exchange resin at 80 meq/L and 400 meq/L.

FIG. 7 is a figure detailing how the ion exchange column was modeled as a series of continuously stirred tank reactors.

FIG. 8A is a plot of the theoretical sulfate concentration and CaSO₄ SI at various stages in the RIX-D process when α_{P/M} is fixed at 1.5. (α_{P/M} is the separation factor value for a polyvalent anion with respect to monovalent anion for an anion exchanger).

FIG. 8B is a plot of the theoretical sulfate concentration and CaSO4 SI at various stages in the RIX-D process when α_{P/M}=1.5 at feed water concentrations and α_{P/M}=0.5 at desalination reject concentration.

FIG. 9 is a plot of the actual ion exchange selectivity for a mixed bed of acrylic strong base anion exchange resin and styrene/divinylbenzene strong base anion exchange resin at 80 meq/L and 400 meq/L.

FIG. 10 is a plot of the CaSO4 SI at the membrane interface for 10 cycles of RIX-D using a mixed bed of acrylic strong base anion exchange resin and styrene/divinylbenzene strong base anion exchange resin.

FIG. 11 is a plot of the CaSO4 SI at the membrane interface for 8 cycles of RIX-D using a bed of styrene/divinylbenzene strong base anion exchange resin.

FIG. 12 is the spectrum from Energy Dispersive X-Ray analysis performed on an anion exchange resin bead after 3 cycles of RIX-D.

### DETAILED DESCRIPTION

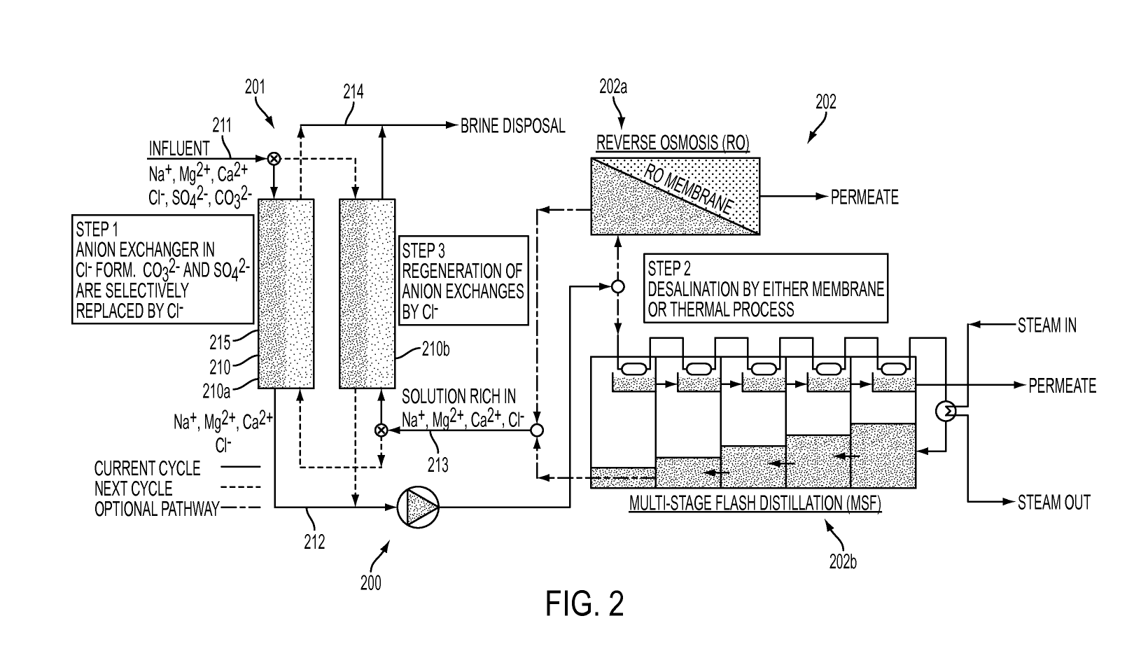

The present invention relates to a method and a system for treating feed water for desalination. Referring to FIG. 2, one embodiment of the system 200 of the present invention is shown. The system comprises a feed water treatment system 201 and a desalination system 202. The desalination system 202 may be any desalination system including a membrane-type system 202a or a thermal-type system 202b.

Regarding the feed water treatment system 201, it comprises: (a) an anion exchange bed 210 for removing one or more polyvalent anions from the feed water; (b) a first input 211 for feeding the feed water into the bed 210; (c) a first output 212 for outputting a treated stream of feed water to a desalination system 202; (d) a second input 213 for feeding a brine stream from the desalination system 202 into the bed 210; (e) a second output 214 for outputting a used brine stream; and (d) one or more anion exchange resins 215 in the bed 210, the mixture of resins selecting polyvalent ions over monovalent ions when contacted with the feed water, and selecting monovalent ions over polyvalent ions when contacted with the brine stream.

The feed water treatment system 201 described above reduces the concentration of polyvalent ions in the treated feed water of the desalination system 202. In one embodiment, the process comprises: (a) removing one or more polyvalent ions from the feed water by feeding the feed water into the bed 210 comprising one or more anion exchange resins 215 under conditions sufficient to exchange the polyvalent ions in the feed water with one or more monovalent ions in the resin; and (b) regenerating the bed by feeding a brine stream from the desalination system 202 into the bed 210 under conditions sufficient to exchange one or more polyvalent ions in the resins with one or more monovalent ions in the brine stream.

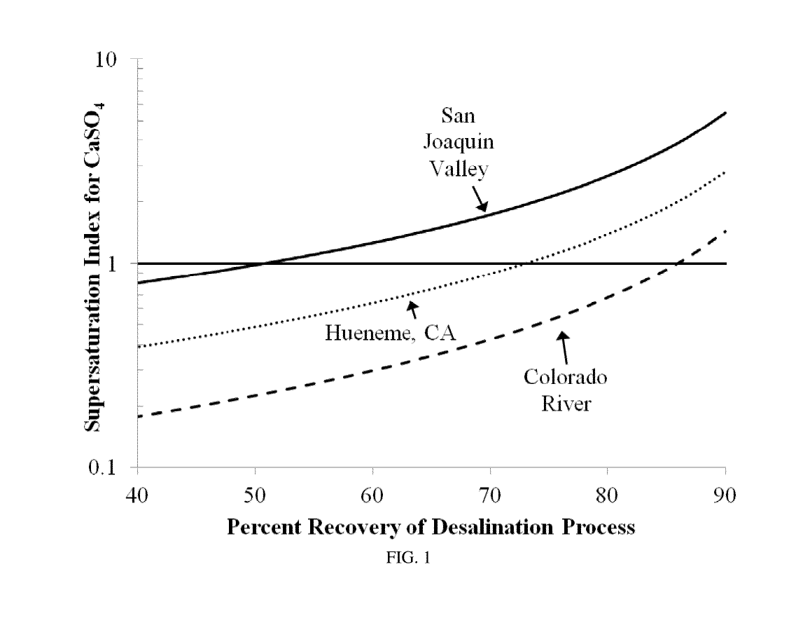

The present invention recognizes the need to reduce the concentration of polyvalent ions in the feed stream to minimize scaling. By way of background, commonly-formed scales during desalination are polyvalent salts of alkaline earth metals, which easily form precipitates with polyvalent anions such as, but not limited to, carbonate (CO₃²⁻), phosphate (HPO₄²⁻), or sulfate (SO₄²⁻)—e.g. CaSO₄, CaCO₃, BaSO₄, etc. The cause of precipitation depends on the desalination process. For membrane desalination like reverse osmosis (RO), scaling occurs due to the phenomenon of concentration polarization whereby the concentration of ions is greater at the surface of the membrane than in the bulk solution. At these concentrations the solubility limit of some salts is exceeded, thus precipitation occurs. Formation of these insoluble salts can foul the membrane and limit its performance. For example, in FIG. 1 the solubility of CaSO4 for various brackish sources from throughout the United States were plotted as a function of recovery from the desalination process. Note that for all feed waters, exceeding 85% recovery results in precipitation of CaSO4. For thermal desalination processes like Multi-stage Flash Distillation (MSF), high operational temperatures (up to 122° C.) promote scale formation and can cause blockages in the heat exchangers.

In general the selective removal of these polyvalent salts allows the desalination process to operate at higher recoveries without threat of scaling. Specifically, replacing these ions with highly soluble monovalent ions, like Cl⁻ or NO₃⁻, would prevent scaling since CaCl₂ or Ca(NO₃)₂ is more soluble than its sulfate, phosphate or carbonate salt by orders of magnitude.

At brackish water concentrations, most commercially-available anion exchange resins show high selectivity toward polyvalent anions, like sulfate, and low selectivity toward monovalent ions, like chloride. In this respect, earlier research included treating the feed with a cation exchange resin in Na-cycle, thus converting bulk of the divalent cations into monovalent sodium ions, thus reducing the risk of precipitation on the RO membrane. Thus, passing the feed water through an anion exchange column would selectively remove carbonate, phosphate or sulfate anions and replace them with monovalent anions. However, the capacity of the anion exchange resin would soon be exhausted. As a result, the process could not be sustained without externally added regenerant chemicals. Past works with cation exchange resins confirmed that the process could not be sustained without addition of external regenerant.

For the process to work in a continuous fashion, the anion exchange column must not only show high selectivity toward polyvalent anions when passing the feed water to prevent precipitate formation in the desalination process, but also upon regeneration, the anion exchange column must prefer instead monovalent anions in order to ensure efficient regeneration of the resin.

The ion exchange parameter that describes the relative preference of one ion over another is the separation factor, a. For example, the preference of the ion exchanger for sulfate over chloride would be represented as α_{P/M}, wherein P refers to the polyvalent ion, i.e., Sulfate, and the M refers to the monovalent ion, i.e., chloride. When α_{P/M}>1, sulfate is more preferred than chloride and when α_{P/M}<1, chloride is more preferred than sulfate. The separation factor, α_{P/M}, for a given anion exchange resin is not a constant and depends on the ionic strength of the solution the resin is in contact with and may be calculated by:

$${α}_{P / M} = \frac{{y}_{P} {x}_{M}}{{x}_{P} {y}_{M}}$$

Where y represents the fraction of each species on the resin and x represents the fraction of each species in solution. The solution is either the feed water or the brine stream depending on whether the bed is treating feed water or being regenerated.

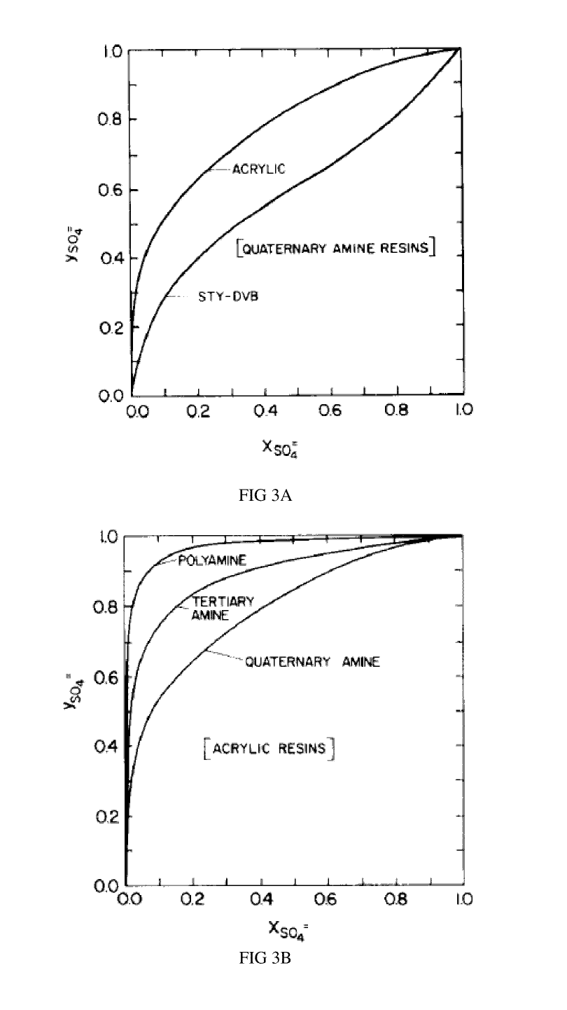

The composition, and therefore the ionic strength, of the feed water is fixed and cannot be changed. Likewise, the recovery of the desalination process is generally limited. Thus, to achieve the desired range of selectivity it is necessary to choose a resin type for a given feed water composition. For ion exchange resins, there are two parameters to choose from: the resin matrix or the resin functional group. As shown in FIG. 3A, resins with an acrylic matrix show higher sulfate selectivity than those with a styrene/divinylbenzene matrix. FIG. 3B shows that resins with weaker base functional groups also show higher sulfate selectivity than those with strong base functional groups (i.e., tertiary vs quaternary). Also, for strong-base functional groups, sulfate selectivity over chloride increases with a decrease in the size of the alkyl group.

For any given feed water composition and operating conditions, different resins can be mixed to attain the desired selectivity. In order to sustain the proposed process without addition of any external regenerant, α_{P/M} neds to be greater than 1 at feed water ionic strength, while at reject brine ionic strength, α_{P/M} should be less than 1. For example, the composition of the San Joqauin Valley feed water is shown in TABLE 1.

TABLE 1
San Joaquin Valley Feedwater Composition

| Ion | M | meq/L |
|---|---|---|
| Na⁺ | 0.0500 | 50.02 |
| Mg²⁺ | 0.0025 | 4.99 |
| Ca²⁺ | 0.0138 | 27.70 |
| Cl⁻ | 0.0567 | 56.71 |
| SO₄²⁻ | 0.0106 | 21.24 |
| HCO₃⁻ | 0.0048 | 4.77 |

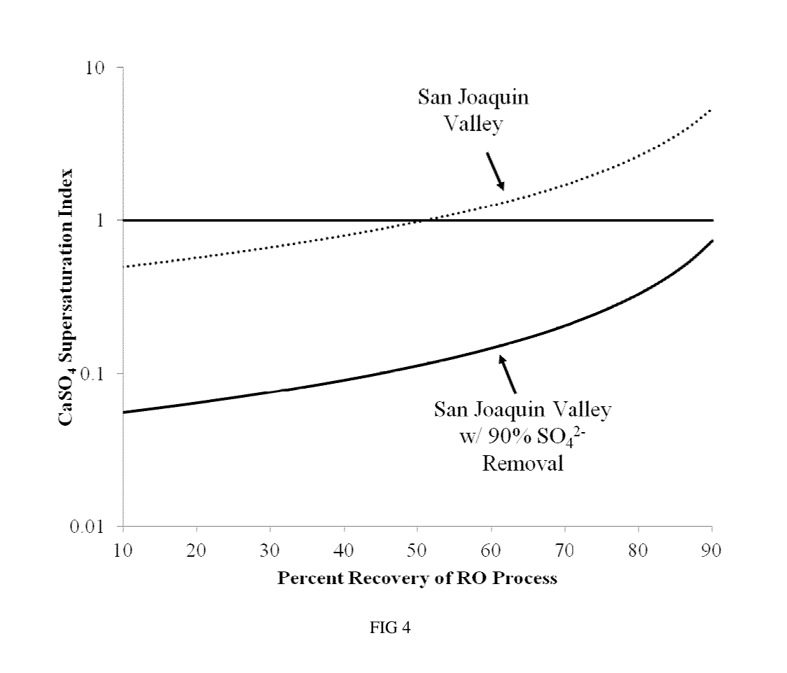

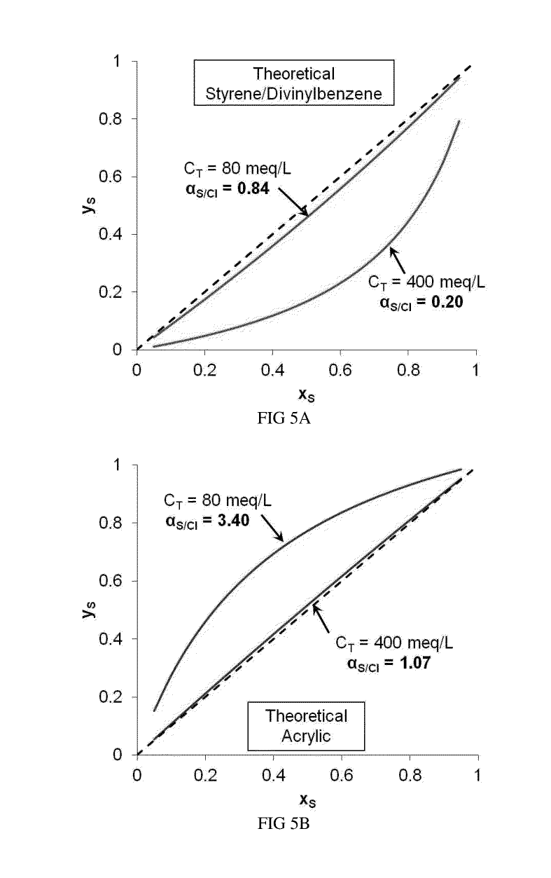

FIG. 1 shows the effect on the potential for CaSO₄ scale formation as a function of the recovery of the desalination process for the San Joaquin Valley Feedwater. At 55% recovery, the supersaturation index (SI) exceeds 1. Above 1, CaSO₄ precipitation is thermodynamically favorable. FIG. 4 shows that if 90% of the incoming sulfate were removed, the process recovery could be increased to 80% without any threat to CaSO₄ precipitation. In order for sulfate to be selectively removed, at influent concentration, 80 meq/L, sulfate/chloride separation factor of α_{P/M} must be greater than 1 while at 80% recovery, 400 meq/L, α_{P/M} must be less than 1. FIG. 5A and FIG. 5B show the predicted values of α_{P/M} at 80 meq/L and 400 meq/L for two different commercially available ion strong base anion exchange resins: an acrylic resin and a styrene/divinylbenzene resin.

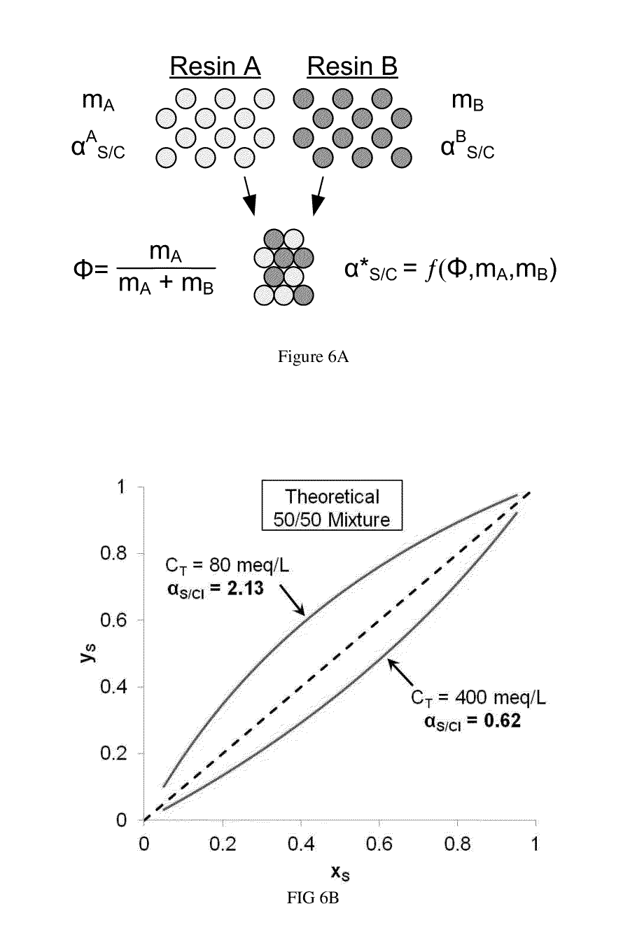

Note that neither resin provides the desired range of selectivities. α_{P/M} for the acrylic resin is always greater than 1 while the styrene/divinylbenzene resin is always less than 1. However, the α_{P/M} value can be controlled by mixing two (or more) different anion exchange resins as shown in FIG. 6A. If the two resins are mixed together in a 50/50 ratio a new range of α_{P/M} is created, shown in FIG. 6B. For this scenario, the desired range of α_{P/M} is created where feed water separation factor α′_{P/M}>1 while a regeneration separation factor, α″_{P/M}<1.

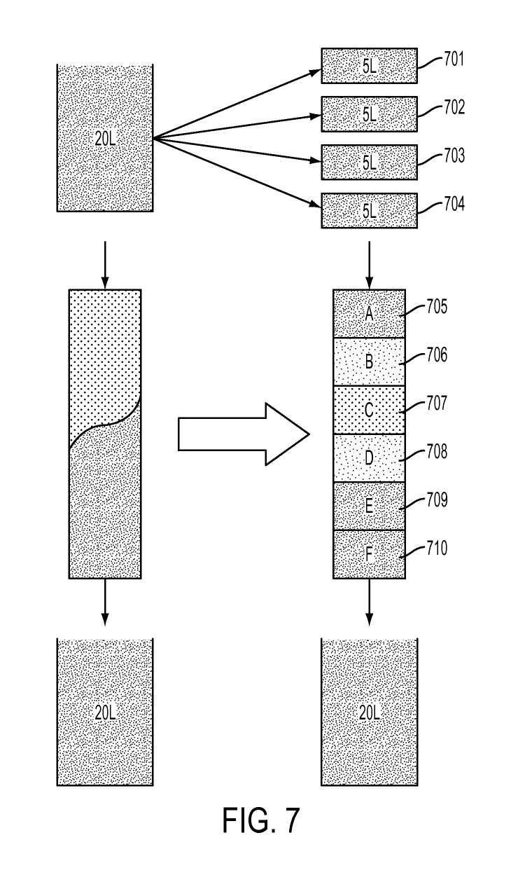

Although theoretical predictions indicate that a feed water separation factor α′_{P/M} must be greater than 1 and the regeneration separation factor α″_{P/M} must be less than one, to demonstrate the effect α_{P/M} has on process efficiency, a simple model of the system was created that simulates the effluent from the IX column/feed to RO system. For the model, the desalination process chosen was reverse osmosis, though similar results would be obtained if a different desalination process was used instead. The desalination process was split into three sections: an ion exchange column in contact with feed water, a reverse osmosis system in contact with ion exchange effluent, and an ion exchange column in contact with reverse osmosis reject brine. Due to the complex modeling associated with an ion exchange column, the influent solution was split into four pieces 701-704, and the ion exchange column was assumed to consist of six batch reactors 705-710 in series as shown in FIG. 7. The inputs to the model are the values of α_{P/M} during normal operation and regeneration, the bed volume, and the volume of solution to pass through the system during each cycle. For each simulation, the model was run for 50 cycles.

One cycle is defined as follows: first, the influent feed water is split into fourths 701-704 and each fourth is passed through the six batch reactor ion exchange column 705-710. Next, the composition of the effluent from each batch reactor is calculated using mass balance. The four pieces are then combined into one homogenous solution and subjected to reverse osmosis. The effluents of the RO process are calculated using another mass balance. Finally, the concentrate stream is then split into fourths and passed back through the ion exchange column.

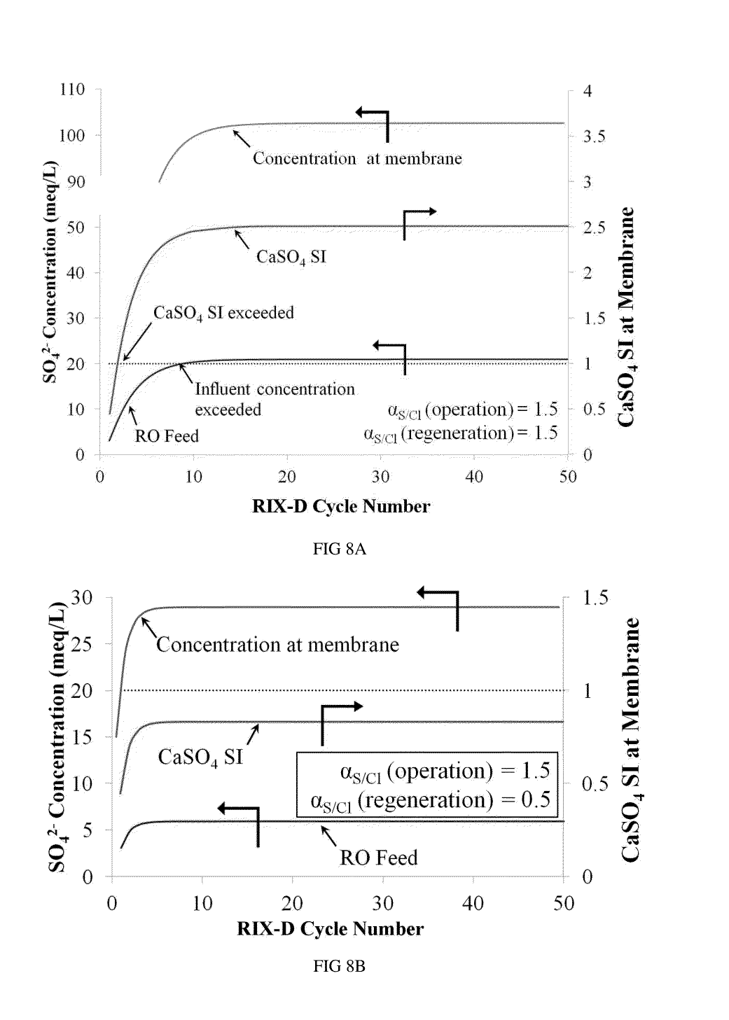

If α_{P/M} is set to be always greater than 1, FIG. 8A shows model predictions that are undesirable. Since no regeneration is occurring, the bed capacity is exceeded in a short number of cycles and eventually reaches influent concentrations. At such high sulfate levels, operation at 80% recovery becomes untenable as CaSO₄ SI is exceeded.

If the model is run again for a more favorable scenario where α′_{P/M}=1.5 during normal operation but α″_{P/M}=0.5 at reject concentrations, the predictions shown in FIG. 8B give a much more favorable situation. For over 50 cycles the SI value for CaSO₄ is significantly lower than 1 thereby completely preventing CaSO₄ precipitation.

Referring back to FIG. 2, one embodiment of the system 200 of the present invention is shown. This schematic shows how the process of the present invention works for two commonly used methods of desalination: a membrane-type system 202a, like reverse osmosis, or a thermal-type system 202b, like multistage flash distillation. Considering, for example, the case of SO₄²⁻ removal and replacement by Cl⁻. Feedwater is fed into the bed 210 through the input 211. In this embodiment, the bed comprises two discrete columns 210a, 210b. Generally, although not necessarily, the feed stream will be fed into one of the discrete columns while the other is undergoing regeneration. Although two discrete columns are shown in FIG. 2, it should be appreciated that the invention is not limited to two columns and that more than two or just one column may be used.

The feed water passes through the mixed anion exchanger resins, causing sulfate to be removed by the following reaction:

2 [symbol] +SO₄²⁻ [symbol] +2Cl⁻

Where the overbar denotes the solid resin phase and R₄N⁺ is the functional group of the anion exchange resin. The treated feed water, which is now free of sulfate or at least has a reduced concentration of sulfate, exits the bed 210 from the output 212 and is fed to the desalination system 202.

The reject brine stream from the desalination system is fed into the bed 210 through another input 213. As mentioned above, generally the brine stream will be passed back through an already exhausted anion exchange bed in sulfate form whereupon sulfate is eluted from the column and replaced by chloride according to the following formula:

[symbol]

+2Cl⁻ [symbol] +SO₄²⁻

In this way, the exhausted bed is regenerated, and then is a ready to receive the feed water to repeat the process described above.

The present invention is further described by reference to the following non-limiting examples.

### EXAMPLE 1

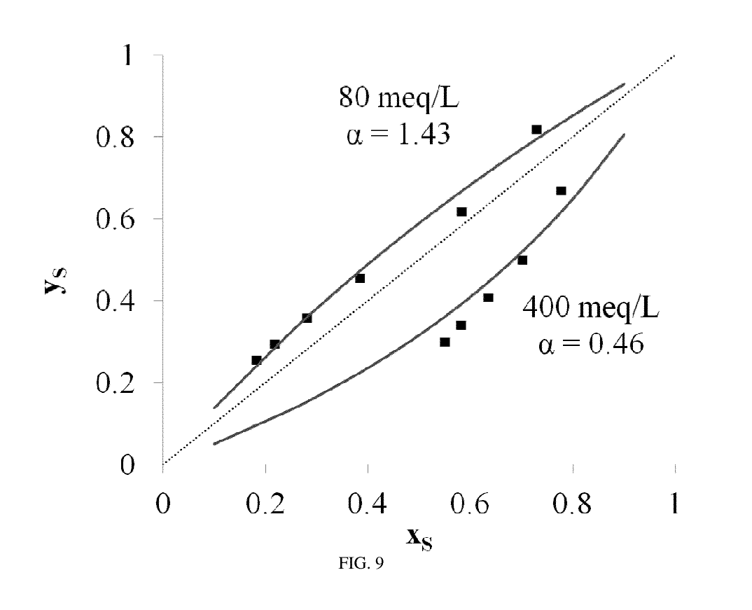

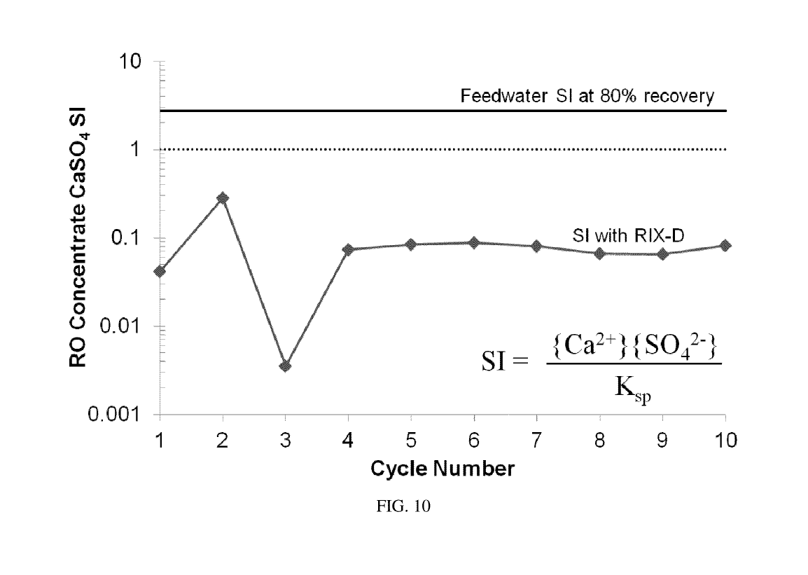

Based on the theoretical predictions from the model, 10 cycles of ion exchange/reverse osmosis were performed using a 50/50 mixture of strong base acrylic and strong base anion exchange resin. The experimental isotherm created by mixing of the resins is similar to the theoretical predictions and shown in FIG. 9. FIG. 10 shows the calculated CaSO₄ SI values at the RO membrane surface considering no sulfate removal. Note that CaSO₄ SI value is exceeded over one favoring precipitation. In contrast, for all 10 cycles during the RIX-D process, CaSO4 SI stayed well below unity with no possibility for precipitation and membrane fouling.

### EXAMPLE 2

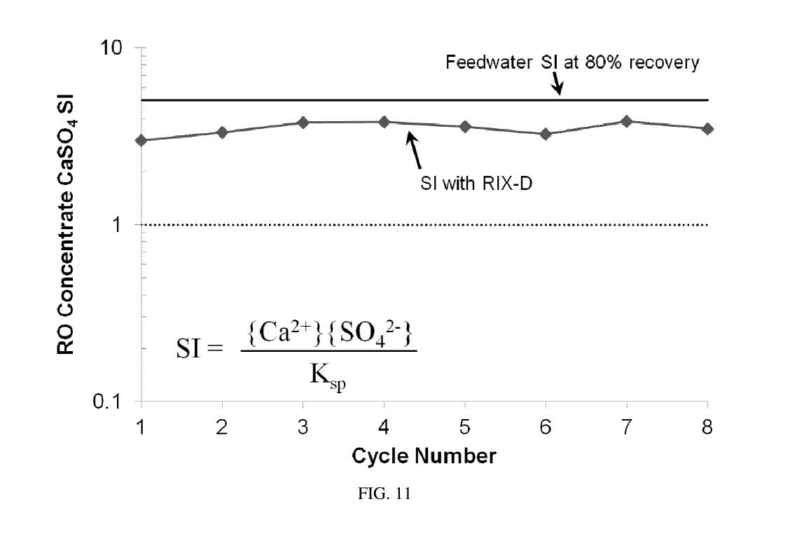

In order to demonstrate that resin mixing has an effect on process efficiency, 8 cycles of ion exchange/reverse osmosis were performed using the modified San Joaquin Valley feed water shown in TABLE 2. For this feed water, theoretical predictions indicate that a column of styrene/divinylbenzene alone is unable to ensure high sulfate removal for the prevention of CaSO4 precipitation since α′_{P/M} is greater than 1 at feed water concentrations. FIG. 11 shows a plot of CaSO4 SI, and for all cycles SI exceeded 1 indicating that CaSO4 precipitation is favorable.

TABLE 2
Modified San Joaquin Valley Feedwater

| Ion | mM | meq/L |
|---|---|---|
| Na⁺ | 90.7 | 90.7 |
| Mg²⁺ | 4.5 | 9.1 |
| Ca²⁺ | 25.1 | 50.2 |
| Cl⁻ | 102.8 | 102.8 |
| SO₄²⁻ | 19.3 | 38.5 |
| HCO₃⁻ | 8.6 | 8.6 |

### EXAMPLE 3

During regeneration of the resin, there is a potential for the local conditions inside both the anion exchange column and/or the ion exchange resin to exceed the solubility of certain salts e.g., CaSO₄. However, the time scale for precipitation of CaSO₄ is much larger compared to the time period which supersaturated CaSO₄ solution is present in the ion exchange column. In order to demonstrate this fact, an ion exchange column was operated using the synthetic feed water and synthetic reverse osmosis concentrate solutions shown in TABLE 3. 20 bed volumes of synthetic feed water was passed through the ion exchange column and collected. Next, 4 bed volumes of synthetic reverse osmosis concentrate were passed as a regenerant and collected in a fractional collector. The contact time of regenerant with the ion exchange resin was 9.6 minutes. Immediately after passing the regenerant, another 20 bed volumes of synthetic influent were passed to mimic real-world operation of the system. This process was repeated for a total of 3 cycles of passing feed water and regenerant. For all cycles, CaSO₄ precipitation occurred in the collected reject solution within 1 hour, but no visible precipitation occurred inside the column.

TABLE 3
Synthetic Influent and RO Concentrate
Feedwater Solution Compositions
Revised Table 3

| | Synthetic | Synthetic RO |
|---|---|---|
| | Influent | Concentrate |
| Ion | meq/L | meq/L |
| Na⁺ | 50 | 250 |
| Mg²⁺ | 5 | 25 |
| Ca²⁺ | 25 | 125 |
| Cl⁻ | 60 | 400 |
| SO₄²⁻ | 20 | 0 |

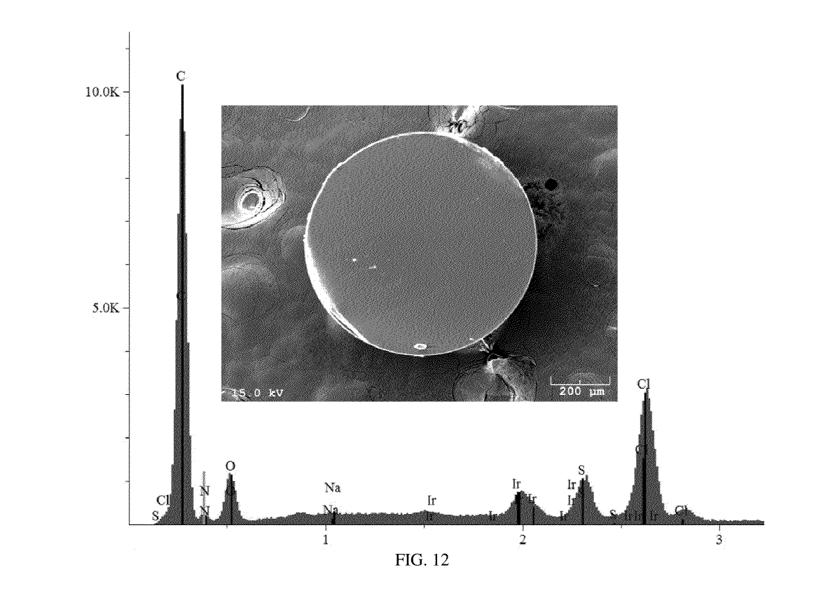

In addition to visible inspection of the column, Energy Dispersive X-ray analysis (EDX) was performed on several resin beads extracted from the column. Analyzed beads did not contain any calcium nor was there any visible precipitates formed. FIG. 12 shows the EDXA spectrum from one of the beads analyzed and a picture of the analyzed bead.

Therefore, based on the disclosure above, A Reversible Ion Exchange-Desalination process (RIX-D) for the desalination of brackish water through the use of mixed-bed anion exchange followed by standard desalination is presented. Feed brackish water is passed through a mixed bed anion exchange resins. Any divalent anions present in solution are preferentially substituted for an equivalent amount of chloride. Chloride salts of divalent cations are orders of magnitude more soluble than sulfate, phosphate or carbonate. The effluent from the ion exchange columns is then subjected to desalination. The replacement of ions that cause scaling allows the desalination process to be operated at higher recoveries without the need for antiscalant or acid dosing. This provides significant cost savings in both the elimination of chemical costs and a lower cost of produced water. The desalination process produces a concentrated reject brine of mostly chloride. This brine is then used to regenerate the ion exchange column without any additional chemical input. Thus, for a reverse osmosis (RO) process fed with brackish water rich in sulfate, the possibility or threat of sulfate scaling on membrane surface can be avoided altogether and percentage recovery can be enhanced. The proposed process is singularly unique due to the invention that for any feed water, composition of anion exchange resins can be modified and tunes to avoid scaling on RO membrane without requiring external addition of chemicals.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

What is claimed is:

1. A process for treating feed water for desalination, said process comprising:
removing one or more polyvalent anions from said feed water by feeding said feed water into a bed comprising one or more anion exchange resins under conditions sufficient to exchange said polyvalent ions in said feed water with one or more monovalent anions in said resin; and
regenerating said bed by feeding a brine stream into said bed under conditions sufficient to exchange one or more polyvalent anions in said resins with one or more monovalent anions in said brine stream.

2. The process of claim 1, wherein said one or more anion exchange resins comprises a mixed bed that exhibits a polyvalent/monovalent separation factor value greater than unity for feed water and less than unity for said brine stream.

3. The process of claim 2, wherein said one or more anion exchange resins is formulated based on the composition of said feed water and desired percentage recovery.

4. The process of claim 1,
wherein said conditions sufficient to exchange polyvalent anions in said feed water with monovalent anions in said one or more anion exchange resins include a feed water separation factor α′_{P/M} greater than about 1, wherein said feed water separation factor α′_{P/M} is defined as follows:
$${α}_{P / M}^{′} = \frac{{y}_{P} {x}_{M}^{′}}{{x}_{P}^{′} {y}_{M}}$$
wherein, y_{P} represents the fraction of said polyvalent ions associated with said one or more anion exchange resins, y_{M} represents the fraction of monovalent ions associated with said one or more anion exchange resins, x′_{P} represents the fraction of polyvalent ions associated with said feed water, and x′_{M} represents the fraction of monovalent ions associated with said feed water; and
wherein said conditions sufficient to exchange one or more monovalent ions of said resins with one or more polyvalent ions in said brine stream include a regeneration separation factor α″_{P/M} less than about 1, wherein the regeneration separation factor α″_{P/M} is defined as follows:
$${α}_{P / M}^{″} = \frac{{y}_{P} {x}_{M}^{″}}{{x}_{P}^{″} {y}_{M}}$$
wherein, x″_{P} represents the fraction of polyvalent ions associated with said brine stream, and x″_{M} represents the fraction of monovalent ions associated with said brine stream.

5. The process of claim 4, wherein said one or more anion exchange resins comprises a mixture of at least two resins, a first resin having a feed water separation factor and a regeneration separation factor each greater than one, and a second resin having a feed water separation factor and a regeneration separation factor each less than one.

6. The process of claim 1, wherein said brine stream is from a desalination system

7. The process of claim 1, wherein said polyvalent anions are one or more of sulfate, phosphate, or carbonate ions.

8. The process of claim 1, wherein said monovalent ion is one or more chloride or nitrate.

9. The process of claim 1, further comprising: desalinizing said treated water.

10. The process of claim 9, wherein desalinizing involves a membrane process.

11. The process of claim 9, wherein desalinizing involves a thermal process.

12. The process of claim 1, wherein said one or more anion exchange resins comprises a single anion exchange resins.

13. A system for treating feed water for desalination, said system comprising:
an ion exchange bed for removing one or more polyvalent ions from said feed water;
a first input for feeding said feed water into said bed;
a first output for outputting a treated stream of feed water to a desalination system;
a second input for feeding a brine stream from said desalination system into said bed;
a second output for outputting a used brine stream; and
one or more anion exchange resins in said bed, said resins selecting polyvalent ions over monovalent ions when contacted with said feed water, and selecting monovalent ions over polyvalent ions when contacted with said brine stream.

14. The process of claim 13, where in one or mixture of two or more anion exchange resins comprises a mixed bed that exhibits a polyvalent/monovalent separation factor value greater than unity for feed water and less than unity for said brine stream.

15. The system of claim 14, wherein said one or more anion exchange resins is formulated based on the composition of said feed water.

16. The system of claim 13,
wherein said one or more anion exchange resins have a feed water separation factor α′P/M greater than about 1, wherein said feed water separation factor α′_{P/M} is defined as follows:
$${α}_{P / M}^{′} = \frac{{y}_{P} {x}_{M}^{′}}{{x}_{P}^{′} {y}_{M}}$$
wherein, y_{P} represents the fraction of said polyvalent ions associated with said one or more anion exchange resins, y_{M} represents the fraction of monovalent ions associated with said one or more anion exchange resins, x′_{P} represents the fraction of polyvalent ions associated with said feed water, and x′_{M} represents the fraction of monovalent ions associated with said feed water; and
wherein said one or more anion exchange resins include a regeneration separation factor α″_{P/M} less than about 1, wherein the regeneration separation factor α″_{P/M} is defined as follows:
$${α}_{P / M}^{″} = \frac{{y}_{P} {x}_{M}^{″}}{{x}_{P}^{″} {y}_{M}}$$
wherein, x″_{P} represents the fraction of polyvalent ions associated with said brine stream, and x″_{M} represents the fraction of monovalent ions associated with said brine stream.

17. A system comprising:
a desalination system;
an ion exchange bed for removing one or more polyvalent ions from said feed water;
a first input for feeding said feed water into said bed;
a first output for outputting a treated stream of feed water to said desalination system;
a second input for feeding a brine stream from said desalination system into said bed;
a second output for outputting a used brine stream; and
one or more anion exchange resins in said bed, said resins selecting polyvalent ions over monovalent ions when contacted with said feed water, and selecting monovalent ions over polyvalent ions when contacted with said brine stream.

18. The process of claim 17, where in one or mixture of two or more anion exchange resins comprises a mixed bed that exhibits a polyvalent/monovalent separation factor value greater than unity for feed water and less than unity for the brine.

19. The system of claim 17,
wherein said one or more anion exchange resins have a feed water separation factor α′_{P/M} greater than about 1, wherein said feed water separation factor α′_{P/M} is defined as follows:
$${α}_{P / M}^{′} = \frac{{y}_{P} {x}_{M}^{′}}{{x}_{P}^{′} {y}_{M}}$$
wherein, y_{P} represents the fraction of said polyvalent ions associated with said one or more anion exchange resins, y_{M} represents the fraction of monovalent ions associated with said one or more anion exchange resins, x′_{P} represents the fraction of polyvalent ions associated with said feed water, and x′_{M} represents the fraction of monovalent ions associated with said feed water; and
wherein said one or more anion exchange resins include a regeneration separation factor α″_{P/M} less than about 1, wherein the regeneration separation factor α″_{P/M} is defined as follows:
$${α}_{P / M}^{″} = \frac{{y}_{P} {x}_{M}^{″}}{{x}_{P}^{″} {y}_{M}}$$
wherein, x″_{P} represents the fraction of polyvalent ions associated with said brine stream, and x″_{M} represents the fraction of monovalent ions associated with said brine stream.

20. The system of claim 17, wherein said one or more anion exchange resins is formulated based on the composition of said feed water.

21. The system of claim 17, wherein said desalination system comprises a membrane system.

22. The system of claim 17, wherein desalination system comprises a thermal process.
